(19) United States
(12) Patent Application Publication
(10) Pub. No.: US 2006/0088702 A1
(43) Pub. Date: Apr. 27, 2006

(54) Pattern formation method and functional film

(75) Inventors: Shinri Sakai, Suwa (JP); Toshimitsu Hirai, Chino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/244,804

(22) Filed: Oct. 6, 2005

(30) Foreign Application Priority Data
Oct. 21, 2004 (JP) 2004-306601

(51) Int. Cl. B05D 5/00; B41M 5/00

(52) U.S. Cl. 428/195.1; 427/256

(57) ABSTRACT

A pattern formation method, in which a functional film of a specified pattern is formed on a substrate using a droplet discharging method, includes: establishing a plurality of sub-regions that divide a design pattern of the functional film; conducting a first plotting step by disposing a first liquid so as to plot a borderline between the sub-regions; and conducting a second plotting step by disposing a second liquid which contains a functional material functioning mainly as the functional film so as to plot the plurality of sub-regions after the first plotting step.

### BACKGROUND

1. Technical Field

The present invention relates to a method for forming a pattern of a functional film using a droplet discharging method and to the functional film formed by the droplet discharging method.

2. Related Art

Recently, as a method for forming a fine wiring pattern such as a semiconductor integrated circuit, a technique using a droplet discharging method has been disclosed (e.g., JP-A-2003-317945). The technique disclosed in this publication is that a liquid body containing a functional material (e.g., a conductive material) is discharged on a substrate from a droplet discharging head, and then the material is disposed on the substrate to form the wiring pattern. Such a technique is known to be very effective in that it can be applied, for example, to a large item small volume production.

However, because the pattern of wires (the functional film) formed by the above-referenced method is very minute, the liquid body disposed on the substrate is largely influenced by its surface/interface kinetics (e.g., surface tension and wettability). Thus, when a plurality of droplets are discharged on top of each other, and the liquid body is thereby formed into droplets are merged into a single body of liquid pattern as a specific pattern, the pattern of the liquid body tends to deform or split due to the kinetic influence, except when the liquid body is disposed on the substrate as an independent droplet. In other words, in some cases, it is difficult to form the pattern of the liquid body on the substrate in compliance with a design pattern.

### SUMMARY

An advantage of the present invention is to provide a pattern formation method, when forming a pattern of the functional film, that enables to form the pattern with precision in terms of its wire width and configuration, and to provide the functional film.

According to an aspect of the invention, a pattern formation method, in which a functional film of a specified pattern is formed on a substrate using a droplet discharging method, includes: establishing a plurality of sub-regions that divide a design pattern of the functional film; conducting a first plotting step by disposing a first liquid body so as to plot a borderline between the sub-regions; and conducting a second plotting step by disposing a second liquid body which contains a functional material functioning mainly as the functional film so as to plot the plurality of sub-regions after the first plotting step.

Here, the functional film means a film form such as luminescent film, colored film, conductive film, and the like that has specific functions. The main functions of these functional films are luminescence, absorbency, and conductivity, respectively. Functional materials having these main functions are, for example, an organic electroluminescence (EL) material used as a luminescent material, a pigment used as an absorbent material, and metal used as a conductive material.

The design pattern indicates a pattern as a motif of a functional film desired to be formed, and it is thus expressed in order to differentiate itself from a pattern being actually formed with the liquid body and the film material.

As described above, when the liquid body is formed into the droplets are merged into a single body of liquid pattern as the specific pattern, there are cases in which the pattern of the liquid is deformed or split due to the influence of the surface tension and wettability. Such behavior of the liquid depends largely on the size, configuration, and the like of the pattern of the liquid disposed on the substrate.

According to the pattern formation method of an aspect of the invention, the pattern formed into a line-like shape in the first plotting step prevents the second liquid from flowing between the sub-regions in the second plotting step. Therefore, it becomes possible to control the behavior of the second liquid disposed on the substrate by the configuration and size of the sub-regions. As a consequence, the pattern can be formed with precision in terms of the wire width and configuration.

Further, it is preferable that the pattern formation method further includes: intermediately drying the first liquid disposed on the substrate so as to form a line-shaped film between the first plotting step and the second plotting step.

In the pattern formation method without the intermediate drying step, selection of the liquid is rather limited (to one that gets solidified by a chemical reaction upon mixing the first liquid with the second liquid, or to one that includes a light curing resin as the first liquid) because it creates problems if the first liquid and the second liquid are the kinds that easily mix with each other. According to this pattern formation method, the line-shaped pattern formed with the first liquid is solidified by drying, and, therefore, there is high degree of freedom in the selection of the first liquid and second liquid.

Further, in the pattern formation method, it is preferable that the first liquid contains the functional material.

Because the main function of the components of the first liquid is the function as the line-shaped film, the components of the first liquid are not necessarily the same as the components of the second liquid, whose main function is as the functional film. However, if the first liquid also includes the functional material (which is not necessarily the same as one included in the second liquid), its function as the functional film improves by the amount of the functional material included. This pattern formation method is particularly suitable when forming the conductive film. In addition, the first liquid and the second liquid may contain completely the same components, or their composition ratios may differ, or different additives may be included in each different liquid.

Furthermore, in the pattern formation method, it is preferable that the first liquid contains a resin component.

In the liquid for forming the functional film, the resin component can be contained for purposes such as to improve fixation of the film. Since the line-shaped film is formed mainly to stop flowage of the second liquid between the sub-regions, it is preferable that the line-shaped film is, as its characteristics, difficult to be re-dissolved in the second liquid and to be wetted against the second liquid. According to this pattern formation method, it is possible to obtain desirable conditions against the re-dissolvability and wettability if the first liquid that contains much of the resin component, that is, that has a high resin composition ratio, is formed into the line-shaped film.

Moreover, the pattern formation method may further include establishing the sub-regions as regions having a configuration determinable by a nearly fixed width in the sub-region establishing step.

In this case, a configuration determinable by a nearly fixed width indicates, for example, a configuration such as rectangle that can be objectively determined by a fixed width. A configuration such as square having the width undistinguishable from the length can also be included as one such configuration. Further, circle or oval is considered as having such a configuration, taking the diameter or the minor axis as the width. Also, a configuration such as trapezoid having a changeable width is also considered as having such a configuration having the nearly fixed width, provided that the change in the width is small.

When the liquid is disposed on the substrate using a certain design pattern, the behavior of the liquid is largely affected by the width of the design pattern. For example, if the liquid is disposed using a design pattern such as one having a wide width region and a narrow width region joined together, the liquid flows from the narrow width region to the wide width region due to the difference in width-dependent curvatures of the liquid surfaces, and film thicknesses at these two regions become different. That is, if the pattern of the liquid is formed including regions having largely different widths, the behavior of the liquid cannot be controlled successfully.

By the pattern formation method according to an aspect of the invention, these problems can be avoided by configuring the sub-regions into having nearly fixed widths.

Additionally, in the pattern formation method, in which the design pattern of the functional film includes an elongated region and in which, in the sub-region establishing step, the sub-regions are established by dividing the elongated region along an elongation direction of the elongated region so as to have a length no larger than a specific length, it is preferable that the specific length is equal to an interval between nearly evenly-spaced bulges that appear on a pattern of a liquid formed when the second liquid is disposed all at once so as to plot a strip-shaped pattern having a same width as that of the elongated region.

In this case, the elongated region does not have to have a configuration made with straight lines but may have a bent and strip-shaped configuration.

When disposing the liquid using the elongated design pattern, there is a case in which expanded portions (bulges) are formed as collected liquid on the pattern of the liquid as a consequence of the behavior of the liquid after it is discharged. According to an understanding of the present inventors, these bulges are thought to appear as a result of trying to lower raised inner pressure when the liquid is discharged and converged into the region having a narrow width.

According to the pattern formation method, when the design pattern of the functional film contains the elongated region, an accurate pattern of the liquid can be formed without creating such expanded portions if the sub-regions are established and divided to become shorter than the occurrence interval of the expanded portions.

Further, it is preferable that the pattern formation method includes: forming a dummy pattern on a dummy substrate prior to the sub-region establishing step by disposing the second liquid so as to plot the strip-shaped pattern having a same width as that of the elongated region; and determining the specific length by the interval between the nearly evenly-spaced bulges that appear on the dummy pattern.

The interval between the expanded portions as described above depends on, for example, the wettability of the liquid to the substrate surface, the surface tension of the liquid, the width of the design pattern, and the amount of the liquid to be disposed and changes depending on the functional film desired to be formed. According to this pattern formation method, it is possible to know beforehand the occurrence interval of the expanded portions by forming the dummy pattern on the dummy substrate that was treated in the same conditions (material of the substrate, surface treatment methods, composition of the liquid, and the like) as those for treating the functional film desired to be formed, and, therefore, the most suitable sub-regions can be established.

In addition, in the pattern formation method, it is preferable that a surface of the substrate having the pattern formed thereon is subjected to a liquid repellent treatment or a bank formation so as to surround a region corresponding to the design pattern of the functional film.

According to this pattern formation method, by carrying out the liquid repellent treatment or bank formation, it is possible to reliably hold the second liquid disposed on the substrate within the sub-regions.

Another aspect of the invention is a functional film formed using a specified pattern, in that: the pattern of the functional film is composed of a line-shaped portion formed using a pattern as a borderline that divides the pattern of the functional film into a plurality of sub-regions and of a main portion partitioned by the line-shaped portion and formed using patterns corresponding to the sub-regions; and at least the main portion contains a functional material functioning mainly as the functional film.

With the functional film according to an aspect of the invention, because the pattern can be formed per each of the sub-regions, which are partitioned by the line-shaped portions formed using a pattern as a borderline between the sub-regions, the pattern is highly precise in terms of its film thickness and configuration.

With the functional film, it is preferable that the line-shaped portion contains the functional material.

Because this functional film contains the functional material also in the line-shaped portion (though not necessarily the same material as that contained in the main portion), it works excellently as the functional film.

With the functional film, it is also preferable that the sub-region is a region having a configuration determinable by a nearly fixed width.

Because the sub-region of this functional film has the configuration determinable by the nearly fixed width, the functional film of the invention is highly precise in the film thickness and configuration of the pattern.

### BRIEF DESCRIPTION OF THE DRAWINGS

The invention will be described with reference to the accompanying drawings, wherein like numbers refer to like elements and wherein:

FIG. 1 is a perspective diagram showing an outline structure of a droplet discharging apparatus used in the present embodiment.

FIG. 2 is a plan view showing one example of gate wiring for a TFT.

FIG. 3 is a flowchart diagram to explain the procedure for forming a pattern of the gate wiring.

FIG. 4A is a diagram showing a design pattern of the gate wiring; FIG. 4B is a diagram showing a design pattern of a dummy pattern.

FIG. 5 is a diagram showing one example of division of the design pattern of the gate wiring into sub-regions.

FIG. 6 is a plan view showing a part of patterns (line-shaped films) of a first liquid formed on a substrate.

FIG. 7 is a plan view showing a part of patterns of a second liquid formed on the substrate.

FIG. 8 is a plan view showing a part of the dummy pattern formed on a dummy substrate.

FIG. 9A and FIG. 9B are cross-sectional diagrams showing a pattern of a liquid of a conventional example in comparison with the present embodiment.

FIG. 10 is a diagram showing division of the design pattern of the gate wiring into sub-regions in a modified example 1.

FIG. 11 is a diagram showing division of the design pattern of the gate wiring into sub-regions in a modified example 2.

FIG. 12 is a diagram showing division of the design pattern of the gate wiring into sub-regions in a modified example 3.

FIG. 13 is a diagram showing division of the design pattern of the gate wiring into sub-regions in a modified example 4.

### DESCRIPTION OF EXEMPLARY EMBODIMENTS

Embodiments of the invention will now be described with reference to the drawings.

It should be noted that, because the following embodiments are preferable working examples of the invention, they entail various technically preferable limitations. However, the claims of the invention are not limited to these embodiments, unless there are statements in the following descriptions that particularly limit the invention. Further, the size ratios of the patterns shown in the drawings that are referred to in the following descriptions are not necessarily identical to the size ratios of an actual pattern.

Structure of Droplet Discharging Apparatus

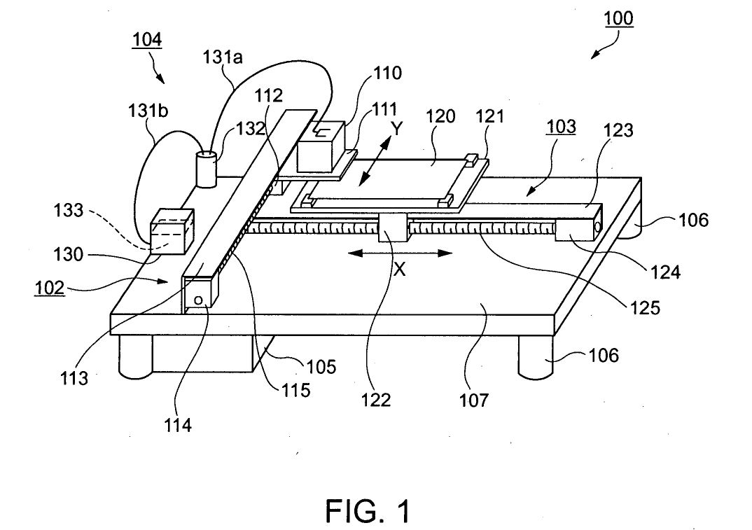

First, a structure of the droplet discharging apparatus used for plotting the pattern is described with reference to FIG. 1. FIG. 1 is a perspective diagram showing an outline structure of the droplet discharging apparatus used in the present embodiment.

A droplet discharging apparatus 100, as shown in FIG. 1, includes: a head unit 102 having a head section 110 that discharges droplets, a substrate unit 103 mounting a substrate 120 which receives the droplets discharged from the head section 110, a liquid supply unit 104 that supplies a liquid 133 to the head section 110, and a control unit 105 that controls all of these units.

The head section 110 has a plurality of nozzles, each of which is able to discharge the droplets towards the substrate. Further, the discharging of droplets can be controlled per each nozzle by the control unit 105. As the substrate 120, almost any flat plate substrate such as a glass substrate, a metal substrate, and a synthetic resin substrate can be used.

The droplet discharging apparatus 100 includes a plurality of supporting legs 106 placed on the floor and a table 107 placed on top of the supporting legs 106. On the table 107, the substrate unit 103 is placed in a longitudinal direction (an X-axis direction) of the table 107. On the substrate unit 103, there is the head unit 102 supported by two posts fixed to the table 107 in a direction (a Y-axis direction) perpendicular to the substrate unit 103. Further, on one end of the table 107, there is the liquid supply unit 104 that supplies the liquid 133 through the head section 110 of the head unit 102. Furthermore, the controller 105 is set below the table 107.

The head unit 102 includes: the head section 110 that discharges the liquid 133, a carriage 111 mounting the head section 110, a Y-axis guide 113 that guides the movement of the carriage 111 in the Y-axis direction, a Y-axis ball screw 115 placed along the Y-axis guide 113, a Y-axis motor 114 that rotates the Y-axis ball screw 115 forward and backward, and a carriage screw section 112 having a female screw portion screwed together with the Y-axis ball screw 115 so as to move the carriage 111.

A moving system of the substrate unit 103 placed in the X-axis direction has almost the same structure as that of the head unit 102 and is composed of a mounting board 121 that mounts the substrate 120, an X-axis guide 123 that guides the movement of the mounting board 121, an X-axis ball screw 125 placed along the X-axis guide 123, an X-axis motor 124 that rotates the X-axis ball screw 125 forward and backward, and a mounting board screw section 122 screwed to the X-axis ball screw 125 so as to move the mounting board 121.

Additionally, although not shown in the drawings, each of the head unit 102 and the substrate unit 103 includes a position detection means that detects positions to which the head section 110 and the mounting board 121 have moved. Further, each of the carriage 111 and the mounting board 121 incorporates a mechanism for adjusting rotational directions, with the axis of the rotational direction being a Z axis perpendicular to the X and Y axes, so as to enable the adjustment of the rotational directions of the head section 110 and the mounting board 121.

Having these structures, the head section 110 and the substrate 120 can move relative to each other freely back and forth in the Y-axis and X-axis directions. To explain the movement of the head section 110, the Y-axis ball screw 115 rotates forward/backward by the forward/backward rotation of the Y-axis motor 114, and, as the carriage screw section 112 screwed to the Y-axis ball screw 115 moves along the Y-axis guide 113, the carriage 111 attached to the carriage screw section 112 moves to a given position. That is, driven by the Y-axis motor 114, the head section 110 mounted on the carriage 111 moves freely in the Y-axis direction. Similarly, the substrate 120 mounted on the mounting board 121 moves freely in the X-axis direction.

As thus described, by the drive control of the X-axis motor 124 and the Y-axis motor 114, the head 110 is able to move relative to the substrate 120 so as to discharge the droplets onto the given positions on the substrate 120. Then, by carrying out this positional control in synchronization with the discharge control at the head section 110, the specified pattern can be plotted on the substrate 120.

The liquid supply unit 104 that supplies the liquid 133 to the head section 110 is arranged on one end of the table 107 and is composed of a tube 131a that forms a flow path linked to the head section 110, a pump 132 that sends liquid to the tube 131a, a tube 131b (a flow path) that supplies the liquid 133 to the pump 132, and a tank 130 that stores the liquid 133 coming in through the tube 131b.

Further, although FIG. 1 shows only a pair of the tank 130 and the tubes 131a and 131b corresponding to the liquid 133, this is only for the sake of avoiding complexity of the drawing. In actuality, the droplet discharging apparatus 100 is structured in a manner that more than one kind of liquid is simultaneously supplied and discharged. In the pattern formation of the functional film to be described hereinafter, the first liquid to be discharged in the first plotting step and the second liquid to be discharged in the second plotting step are prepared, each of which is to be supplied to the head section 110.

Formation of Gate Wiring

In the following, the pattern formation of the functional film will be described, taking the gate wiring for the TFT as an example. It should be noted that the gate wiring in the following descriptions is only an example of the functional film and that there are widely varied functional films applicable in the invention, such as a conductive film (wire) of any pattern in electronic devices, a light-emitting cell film in organic electroluminescence (EL) display panels, and a color filter film in liquid crystal display panels.

Structure of Gate Wiring

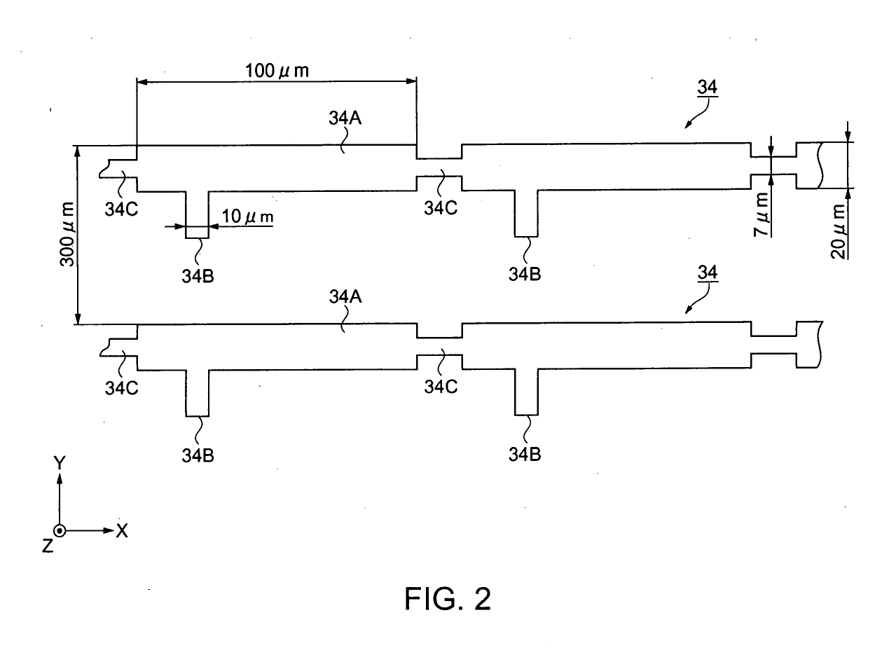

FIG. 2 is a diagram showing one example of the gate wiring for the TFT.

In FIG. 2, gate wiring 34 corresponds to the functional film of the invention. Each of the plurality of gate wirings 34 formed in stripes includes a wide width section 34A, a gate electrode section 34B, and a narrow width section 34C. Note that, in FIG. 2, ratios of the lengths and widths of the wide width section 34A, the gate electrode section 34B, and the narrow width section 34C are not necessarily identical to the actual ratios.

The wide width section 34A is the main portion that extends in the X-axis direction in the gate wiring 34. Further, the width of the wide width section 34A, that is, the length in a direction perpendicular to the longitudinal direction of the wide width section 34A, is larger than the width of the gate electrode section 34B or of the narrow width section 34C. More specifically, the width of the wide width section 34A is about 20 μm.

The gate electrode section 34B is a section protruding in the Y-axis direction from the wide width section 34A and is the gate electrode of the TFT element. The width of the gate electrode section 34B is about 10 μm and is shorter than the width of the wide width section 34A.

The narrow width section 34C is a section having the width narrower than the width of the wide width section 34A in the gate wiring 34. This section is intersected three-dimentionally with source wiring and drain wiring (neither is shown) that are formed in a subsequent device manufacturing process and is thus narrowly formed so as to reduce capacitance produced by the stacked wires. More specifically, the width of the narrow width section 34C is about 7 μm.

Outline Structure of Liquid

As the liquid for forming the gate wiring 34, both the first and second liquid bodies are used in the embodiment. However, since the structures of the two are much alike, they are together referred to as the liquid in the descriptions herein.

As the liquid for forming the gate wiring 34, a dispersion medium having conductive fine particles as the functional material dispersed therein is used. As the conductive fine particle dispersed in the liquid, in addition to a fine metal particle containing any of gold, silver, copper, palladium, and nickel, a fine metal particle of a conductive polymer, a superconductive fine particle, or the like is used.

These conductive fine particles can be used by coating an organic matter on their surfaces in order to improve diffusiveness. A coating material used coat the surface of the conductive fine particle may be citric acid or the like.

The particle diameter of the conductive fine particle is preferably from 5 nm or more to 0.1 μm or less. If the particle diameter is bigger than 0.1 μm, the nozzle of the head of the droplet discharging apparatus as will be described hereinafter is easily clogged, and the discharge by the nozzle by the droplet discharging method becomes difficult. Further, if the particle diameter is smaller than 5 nm, a volume ratio of the coating material to the conductive fine particle becomes great, and a proportion of the organic matter in the resultant film will be too great.

Preferably, the diffusion medium of the liquid containing the conductive fine particles has a vapor pressure at room temperature of between 0.001 mmHg or more and 200 mmHg or less (about 0.133 Pa or more and 26,600 Pa or less). If the vapor pressure is higher than 200 mmHg, the dispersion medium evaporates so quickly after the discharge that it becomes difficult to form a desirable film.

More preferably, the vapor pressure of the diffusion medium is between 0.001 mmHg or more and 50 mmHg or less (about 0.133 Pa or more and 6,650 Pa or less). If the vapor pressure is higher than 50 mmHg, the nozzle gets clogged easily when the droplets are dried after being discharged by the droplet discharging method, and a stable discharge becomes difficult.

In contrast, if the diffusion medium has 0.001 mmHg or less of the vapor pressure at room temperature, the drying becomes slow and the diffusion medium tends to remain in the film, and, therefore, a good conductive film cannot be easily obtained after a heat and/or optical treatment which is a post treatment.

The diffusion medium to be used is not limited to any particular diffusion medium as long as it can diffuse the above-referenced conductive fine particle and does not aggregate. More specifically, in addition to water, it can be: alcohol such as methanol, ethanol, propanol, butanol, or the like; a hydrocarbon compound such as n-heptane, n-octane, decane, toluene, xylene, cymene, durene, indene, dipentene, tetrahydronaphthalene, decahydronaphthalene, cyclohexyl benzene, or the like; an ether compound such as ethyleneglycol dimethyl ether, ethyleneglycol diethyl ether, ethyleneglycol methyl ethyl ether, diethyleneglycol dimethyl ether, diethyleneglycol diethyl ether, diethyleneglycol methyl ethyl ether, 1,2-dimethoxyethane, bis(2-methoxylethyl) ether, p-dioxane, or the like; a polar compound such as proplylene carbonate, y-butyrolactone, n-methyl-2-pyrrolidone, dimethyl formaldehyde, dimethyl sulfoxide, cyclohexanone, or the like. Among these, water, alcohol, a hydrocarbon compound, and an ether compound are preferable in view of the diffusiveness of the fine particle, stability of the diffusion, and applicability to the droplet discharging method. Water and the hydrocarbon compound are more preferable as the diffusion medium. These diffusion mediums can be used singly, or as a mixture of two or more thereof.

A dispersoid concentration of the conductive fine particle is preferably from 1 wt. % or more to 80 wt. % or less and can be adjusted according to a desired thickness of the conductive film. If the concentration exceeds 80 wt. %, aggregation tends to occur, and an even film will be difficult to obtain.

The surface tension of the liquid is preferably in the range of between 0.02 N/m or more and 0.07 N/m or less. If the surface tension is less than 0.02 N/m during the discharge of the liquid by the droplet discharging method, the wettability of ink constituents to the nozzle surface increases, causing the liquid to easily defect. If the surface tension exceeds 0.07 N/m, a meniscus configuration at the tip of the nozzle becomes unstable, making it difficult to control the amount and timing of the discharge.

In order to adjust the surface tension, a trace of fluorine, silicone, or nonionic surface tension regulator, for example, can be added to the diffusion liquid so as not to unduly reduce a contact angle of the diffusion liquid to a substrate S. The nonionic surface tension regulator improves the wettability of the liquid to the substrate, improves leveling property of the film, and prevents lumps (pimples) and orange peel or the like from appearing on the coating film.

The dispersion may include, when necessary, alcohol, ether, ester, or ketone organic compound, for example.

Further, in order to improve fixation of the formed film, a binder resin can be added to the liquid as a resin component. As the binder resin, a copolymer or the like of acrylic acid and styrene is used. In view of the fixation of the formed film, it is preferable that much binder resin is contained; however, in view of the conductiveness, which is the main function of the conductive film, it is preferable that little binder resin is contained.

It is preferable that viscosity of the diffusion liquid is between 1 mPa·s or more and 50 mPa·s or less. When the diffusion liquid discharged by the droplet discharging method has the viscosity of less than 1 mPa·s, an area around the nozzle is easily contaminated by the ink outflow, while, if the viscosity is more than 50 mPa·s, the clogging at the nozzle hole occurs frequently, making it difficult to smoothly discharge the liquid.

General Description of Procedure for Forming Gate Wiring

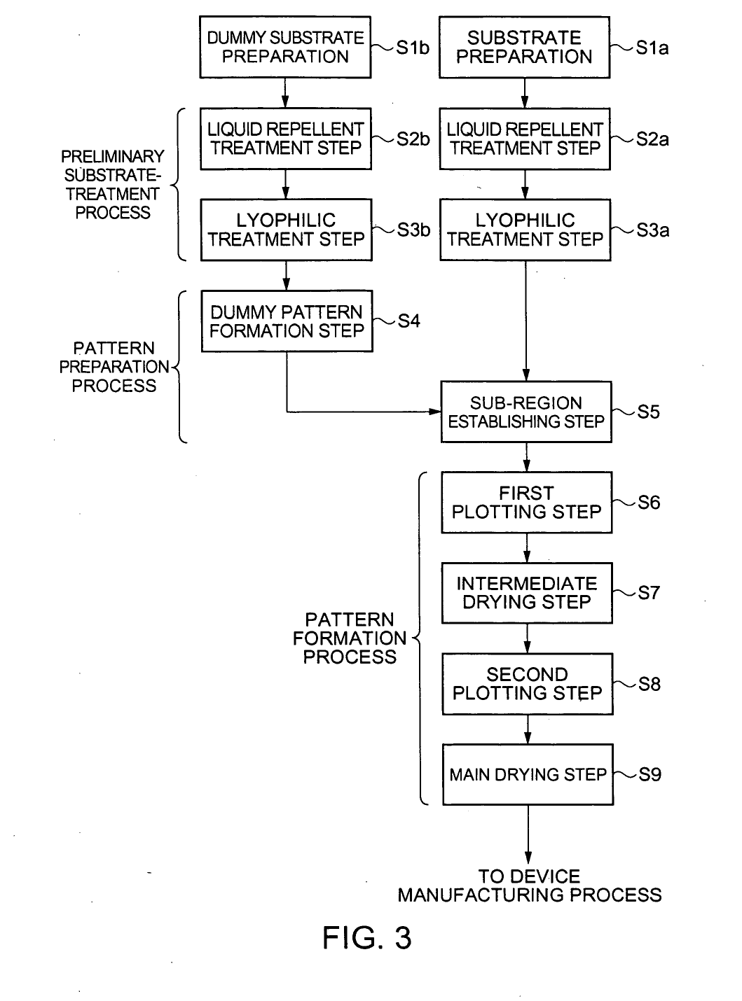

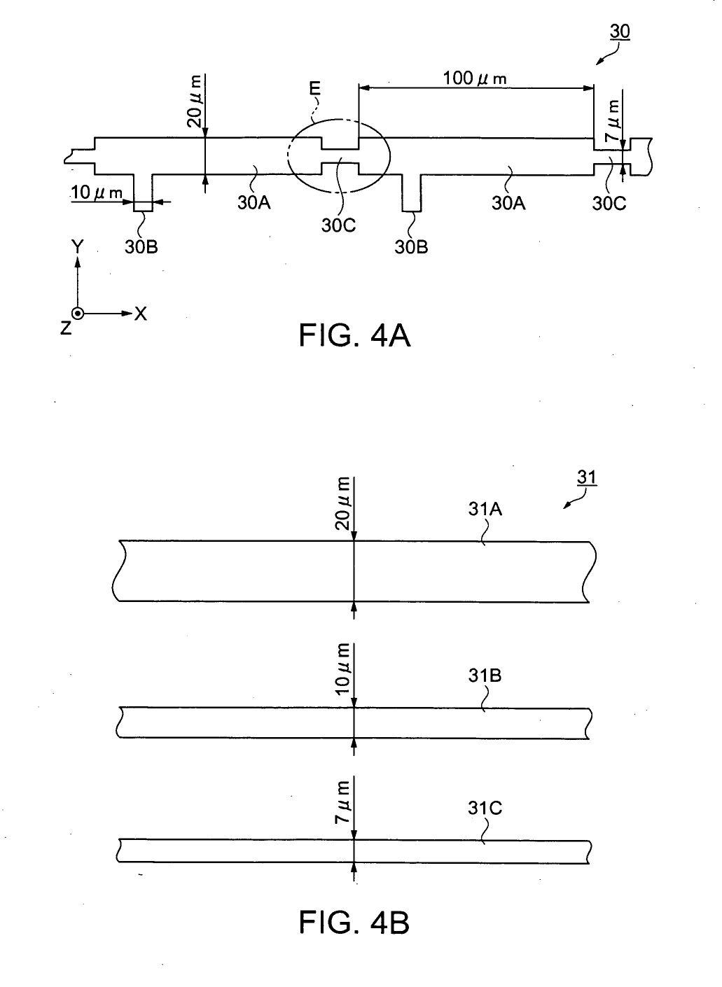

Hereafter, a general description of the procedure for forming the gate wiring is described with reference to FIGS. 4-7, by following the flowchart diagram of FIG. 3. FIG. 3 is the flow chart diagram to explain the procedure for forming the pattern of the gate wiring. FIG. 4A is a diagram showing a design pattern of the gate wiring. FIG. 4B is a diagram showing a design pattern of the dummy pattern. Here, the design pattern means a pattern as a motif of the functional film desired to be formed, and it is thus expressed in order to differentiate itself from the pattern being actually formed with the liquid and the film material.

Prior to the pattern formation of the gate wiring 34 (see FIG. 2), the substrate is first prepared (S1a of FIG. 3). As a material for the substrate, glass, silicone, resin, or the like is suitably chosen for use depending on the type and part of the device to be manufactured; however, in the embodiment, a glass substrate is used. Further, in this case, a substrate is prepared as the dummy substrate (S1b of FIG. 3) in the same conditions (material, surface smoothness, etc.) as those employed for the product.

Next, a liquid repellent treatment is conducted (S2a of FIG. 3) to the substrate surface (a side of the surface where the wiring pattern is formed). As the liquid repellent treatment, there is a method for forming, for example, self assembled monolayers (SAMs) on the substrate surface. The self-assembled monolayers are fine single layers of molecules whose linear chain molecules are formed on the film formation surface. When a compound, whose functional groups that are bindable to constituent atoms of the formation surface of the film are bound to linear molecules, coexists with the constituent surface in a gaseous or liquid state, the functional groups are absorbed to the film formation surface and bound to the constituent atoms of the formation surface. In the embodiment, the substrate and heptadecaflurorotetrahydrodecyltriethoxysilane are let to stand in a same sealed container for 96 hours at room temperature to form the self-assembled monolayers. Further, at this point, the already prepared dummy substrate is also subjected to the liquid repellent treatment in the same conditions (S2b of FIG. 3).

After the liquid repellent treatment (S2a of FIG. 3), a lyophilic treatment is conducted (S3a of FIG. 3) to a region where the gate wiring of the substrate surface is formed. More specifically, via a mask that was die-cut using the design pattern of the gate substrate (see FIG. 4A), oxygen in a plasmatic state is irradiated (a plasma treatment method) so as to remove the self-assembled molecules and other attached impurities in the irradiated region.

By this step, the lyophilic region is formed using the design pattern of the gate wiring on the substrate surface. Further, since a region outside the lyophilic region is the liquid repellent region, it is possible to accurately form the pattern of the fine liquid in accordance with the design pattern in the pattern formation process which will be described hereinafter.

At this time, the already prepared dummy substrate is also subjected to the same lyophilic treatment (S3b of FIG. 3). However, the lyophilic region to be formed is different from a regular substrate in a manner that it has a shape of a thin strip as shown in FIG. 4B.

The above-described liquid repellent treatment step and lyophilic treatment step are together called a preliminary substrate-treatment process. The preliminary substrate-treatment process is carried out in order to accurately form the pattern of the liquid in accordance with a design pattern 30. However, the preliminary substrate-treatment process is not an essential process when carrying out the later-described pattern formation process, nor is it essential in order to produce the effect of the invention.

As the preliminary treatment process of the substrate, there is a method, other than the above-referenced method, called bank formation as will be described herein.

The bank formation is a method by which a bank-shaped resin structure (a bank) is formed on the substrate along a contour of the design pattern by use of a resist technique. As the resin, acrylic resin, polyimide resin, or the like is used.

The substrate surface may be subjected to the lyophilic treatment prior to this bank formation, or a bank portion may be subjected to the liquid repellent treatment after it is formed. The liquid repellent treatment method in this case is, for example, a plasma processing method (a CF₄ plasma processing method) in which tetrafluoromethane is used in the atmosphere as the treatment gas. Further, the liquid repellent treatment may be omitted by using a material having liquid repellency (e.g., a fluorine-containing resin material) as the bank resin.

After the lyophilic treatment steps (S3a and S3b), the second liquid is discharged onto the dummy substrate so as to plot a design pattern 31 as shown in FIG. 4B so that the dummy pattern is formed (S4 of FIG. 3). In this case, an amount of the second liquid disposed on the dummy substrate is equal to an amount necessary to obtain a film thickness of the gate wiring 34 (see FIG. 2) as a final product.

In FIG. 4B, the design pattern 31 of the dummy pattern is composed of thin strip-shaped portions 31A, 31B, and 31C, the width of the strip-shaped portion 31A being equal to the width of the wide width section 34A (corresponding to the wide width section 34A of FIG. 2) of the design pattern 30 of the gate wiring. Further, the width of the strip-shaped portion 31B is equal to the width of the gate electrode section 30B (corresponding to the gate electrode section 34B of FIG. 2) of the design pattern 30 of the gate wiring, and the width of the strip-shaped portion 31C is equal to the width of the narrow width section 30C (corresponding to the narrow width section 34C of FIG. 2) of the design pattern 30 of the gate wiring.

Although the dummy pattern formation step is a step closely involved with the following sub-region establishing step (S5 of FIG. 3), it will be described in detail later below.

After the step of forming the dummy pattern, the design pattern 30 of the gate wiring shown in FIG. 4A is divided into sub-regions (the sub-region establishing step S5 of FIG. 3). This step of establishing the sub-regions is not a step to conduct any process on the substrate but is a type of an information process.

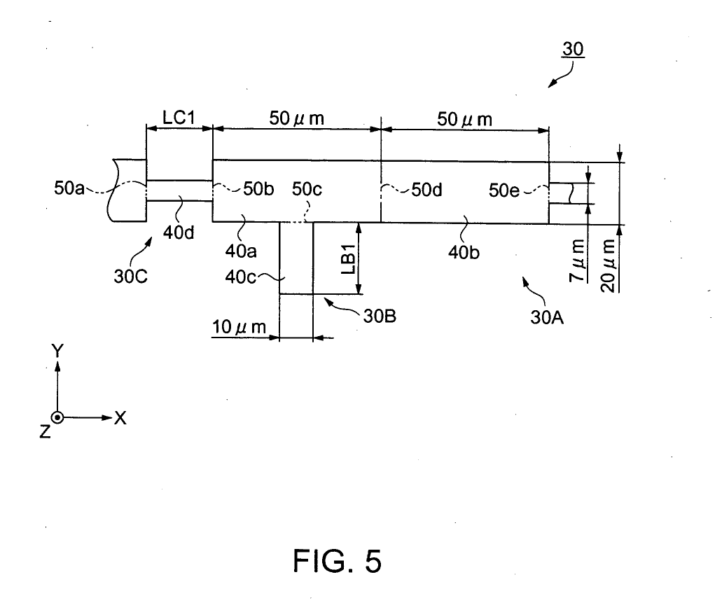

FIG. 5 is a diagram showing one example of the division of the design pattern of the gate wiring into sub-regions. In this drawing, the borders between the adjoining sub-regions are expressed as borderlines 50a-50e shown in imaginary lines.

As shown in FIG. 5, the design pattern 30 is divided into rectangular sub-regions 40a-40d. The wide width section 30A is composed of the sub-regions 40a and 40b having 20 μm in width×50 μm in length. The region of the gate electrode section 30B is the sub-region 40C having 10 μm in width×LB1 in length. The region of the narrow width section 30C is the sub-region 40d having 7 μm in width×LC1 in length.

As thus shown, the design pattern 30 having a complex configuration is divided into the rectangular sub-regions 40a-40d, which are determined by the fixed widths and fixed lengths. As for the establishment of the sub-regions, there are a few points of concern, and, therefore, it will be described in detail later below even though it is a step closely involved also with the following dummy pattern formation step (S4 of FIG. 3).

Upon establishing the sub-regions, the liquid is discharged (a first plotting step S6 of FIG. 3) based on the design pattern 30 (see FIG. 5) with its sub-regions having been established. More specifically, the design pattern 30 shown in FIG. 5 is stored in the droplet discharging apparatus 100, and the substrate that has been treated in the preliminary substrate treatment (S2a and S3a of FIG. 3) is mounted on the mounting board 121 (see FIG. 1) of the droplet discharging apparatus 100 in order to perform the plotting by the droplet discharging method.

In the descriptions hereinafter, the liquid discharged in the first plotting step is called “the first liquid,” and the liquid discharged in a later-described second plotting step (S8 of FIG. 3) is called “the second liquid” in order to distinguish the two. The composition of the two liquid bodies may be completely identical; however, in this embodiment the binder resin added to the first liquid is particularly used.

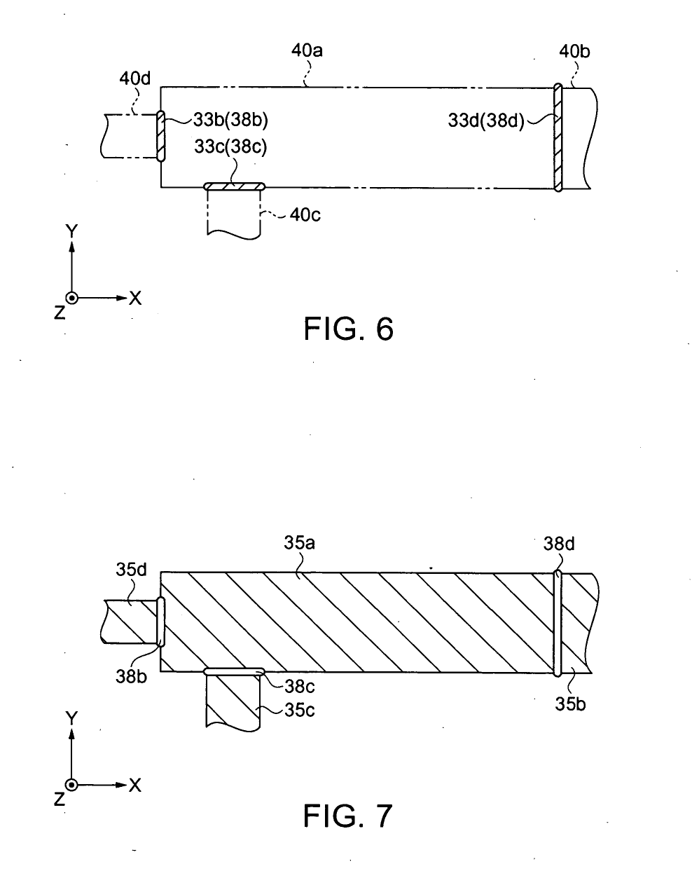

FIG. 6 is a plan view showing a part of the patterns (the line-shaped patterns) of the first liquid formed on the substrate. In the drawing, the regions in hypothetical lines indicate the design pattern (the sub-regions) shown in FIG. 5.

As shown in FIG. 6, in the first plotting step, the liquid is discharged so as to plot the borderlines 50b, 50c, and 50d (see FIG. 5) of the design pattern 30, and, thereby, line-shaped patterns 33b, 33c, and 33d shown in hatched lines are formed. The patterns 33b, 33c, and 33d can be formed having a very narrow width worth about 1-2 dots of the droplet.

Next, the patterns 33b, 33c, and 33d of the first liquid are dried so as to fix the functional material and the like contained in the first liquid on the substrate (an intermediate drying step S7 of FIG. 3). This drying step can be carried out by transferring the substrate to a dryer, or by leaving the substrate on the mounting board 121 (see FIG. 1) and using a manufacturing equipment equipped with both the droplet discharging apparatus (see FIG. 1) and the dryer.

By this drying step, the diffusion medium and various kinds of solvents of the first liquid are evaporated, thereby forming line-shaped films 38b, 38c, and 38c as the conductive films containing the conductive material. As a result, the sub-regions 40a and 40d are partitioned by the line-shaped film 38b; the sub-regions 40a and 40c are partitioned by the line-shaped film 38c; and the sub-regions 40a and 40b are partitioned by the line-shaped film 38d, respectively.

Onto the substrate having the line-shaped films 38b, 38c, and 38d formed thereon by the intermediate drying step, the second liquid is next discharged (the second plotting step S8 of FIG. 2). More specifically, the second liquid is discharged so as to plot the sub-regions 40a, 40b, 40c, and 40d of FIG. 6, thereby forming the patterns of the second liquid.

FIG. 7 is a plan view showing a part of the patterns of the second liquid formed on the substrate.

In FIG. 7, patterns 35a, 35b, 35c, and 35d of the second liquid shown in hatched lines are formed as patterns respectively corresponding to the sub-regions 40a, 40b, 40c, and 40d of FIG. 6. Since the substrate surface is already subjected to the lyophilic/liquid repellent treatment in accordance with the design pattern 30 of the gate wiring shown in FIG. 4A, it is possible to form the patterns having a sharp contour.

Further, in this case, the patterns 35a, 35b, 35c, and 35d of the second liquid are partitioned by the line-shaped films 38b, 38c, and 38d so that the liquid does not move between the adjoining patterns. That is, the patterns 35a, 35b, 35c, and 35d of the second liquid are each independently controlled by the kinetic system of its own. In other words, it can be said that the patterns are controlled based on the division into sub-regions 40a, 40b, 40c, and 40d (per each sub-region).

In order to effectively control the patterns of the second liquid per each sub-region, it is desirable that the patterns 35a, 35b, 35c, and 35d corresponding to the respective sub-regions be partitioned reliably by the line-shaped films 38b, 38c, and 38d. Therefore, in the embodiment, the binder resin is added to the first liquid so that the line-shaped films 38b, 38c, and 38d do not easily get re-dissolved by the second liquid but be appropriately liquid-repellent against the second liquid. In particular, when the line-shaped films 38b, 38c, and 38d are formed, it is preferable that the composition of the first liquid be determined so that the surfaces of the line-shaped films 38b, 38c, and 38d have a higher liquid repellency than the lyophilic region of the substrate surface.

In contrast, because the binder resin in contained, an electric resistance of the line-shaped films 38b, 38c, and 38d becomes slightly high, while, because the first liquid contains enough conductive material, its function as the functional film is hardly affected. Further, in order to minimize the electric resistance, it is desirable that the line-shaped films 38b, 38c, and 38d have a minimum width required for the partitioning into the patterns 35a, 35b, 35c, and 35d of the second liquid. It is to be noted that, depending on the kind of the functional film or on a required specification (such as when forming the colored film), it is possible to compose the first liquid without including the functional material at all.

In addition, the line-shaped films 38b, 38c, and 38d can be formed thick by repeating, for example, the first plotting step and the intermediate drying step. When thus formed, the line-shaped films 38b, 38c, and 38d can play more powerful a role as a weir to prevent the movement of the second liquid.

After forming the patterns 35a, 35b, 35c, and 35d of the second liquid, they are transferred on the substrate, for example, to the dryer to be dried (a main drying step S9 of FIG. 3) so that the functional material contained in the second liquid is fixed on the substrate. In this case, the portion of the patterns 35a, 35b, 35c, and 35d of the second liquid, as the main portion of the gate wiring 34, is unified with the already formed line-shaped films 38b, 38c, and 38d so as to form the gate wiring 34 (see FIG. 2). With the unified gate wiring 34, a portion of the line-shaped films 38b, 38c, and 38d is called a line-shaped portion.

The substrate having the gate wiring 34 (see FIG. 2) formed thereon is baked, if necessary, and sent for the device manufacturing process and used, for example, as wiring in a display device and the like.

Detailed Procedure of Pattern Preparation

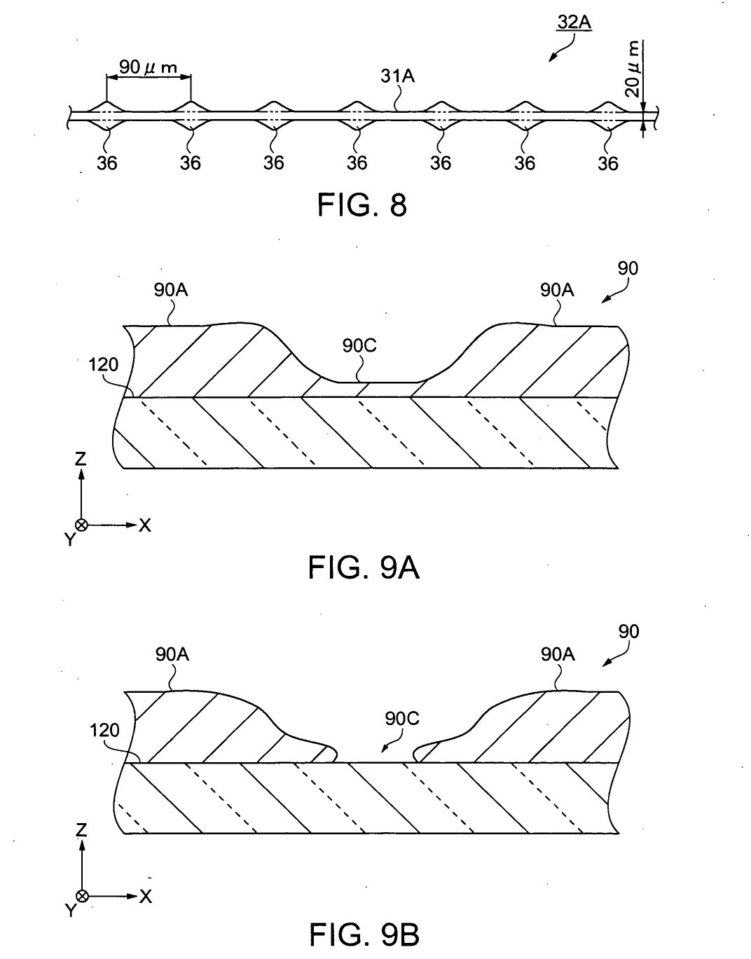

In the previous steps, the dummy pattern formation step (S4 of FIG. 3) and the sub-region establishing step (S5 of FIG. 3) are together called a pattern preparation process. In the following, these steps will be described in detail with reference to FIGS. 8 and 9.

FIG. 8 is a plan view showing a part of the dummy pattern formed on the dummy substrate and showing a pattern corresponding to the strip-shaped portion 31A of FIG. 4B.

In FIG. 8, the dummy pattern 32A composed of the second liquid (hereinafter simply referred to as the liquid) is not identical to the strip-shaped portion 32A, as the design pattern shown in hypothetical lines, and has bulges 36 (expanded portions) that are collected liquid produced at equal intervals. Thus, even if the liquid (the droplet) accurately lands in the substrate in compliance with the design pattern (the strip-shaped portion 31A), there is a case in which the liquid deforms or splits due to the influence of its kinetic behavior such as the wettability and the surface tension. One such case is the occurrence of the bulges 36 at the time of plotting the liquid using the elongated design pattern. According to an understanding of the present inventors, these bulges 36 are thought to appear as a result of trying to lower the raised inner pressure when the liquid is discharged and converged in the narrow width region.

Additionally, although a detailed description is omitted, nearly evenly-spaced bulges occur in the dummy patterns corresponding to the strip-shaped portions 31B and 31C as shown in FIG. 4B. There is a tendency that the narrower the width of the pattern, the shorter the intervals between the bulges become.

It is important to know beforehand that on what conditions the bulges as those on the dummy pattern 32A of FIG. 8 occur, since the wiring film according to the design pattern cannot be formed if the bulges occur during the pattern formation of the liquid. However, because the conditions of the bulge occurrence change depending on the lyophilic property of the lyophilic region, the liquid repellency of the liquid repellent region, the surface tension of the liquid, the width of the strip-shaped portion, the amount of the liquid to be disposed, and so forth, it is difficult to determine which conditions are applicable to varied liquid bodies (functional materials) and varied patterns by, for example, calculation.

This dummy pattern formation step is provided as a consequence of such a situation. In other words, by forming the dummy pattern using the strip-shaped patterns having the same widths as those of the elongated regions, that is, of the wide width section 30A, gate electrode section 30B, and narrow width section 30C of the design pattern 30 (see FIG. 4A) of the gate wiring, it becomes possible to find a relationship between the conditions of the bulge occurrence and the widths of the patterns.

For example, in the example of the dummy pattern 32A shown in FIG. 8, the interval between the bulges 36 is about 90 μm. Therefore, if the pattern of the liquid is formed all at once using the design pattern 30 of FIG. 4A, the bulges are most likely to occur at the region corresponding to the elongated wide width section 30A having the length of 100 μm. In the embodiment, as shown in FIG. 5, the wide width section 30A is divided into the rectangular sub-regions 40a and 40b having 20 μm in width×50 μm in length. Thus, by dividing the wide width section 30A into the sub-regions, each having the length no larger than the interval of the bulge occurrence on the dummy pattern 32A (about 90 μm), the bulges can be prevented beforehand from occurring during the pattern formation of the liquid.

The same can be said with the regions corresponding to the gate electrode section 30B and narrow width section 30C. However, in the embodiment, because the lengths of the sub-regions 40c and 40d are shorter than the intervals of the bulge occurrence on the dummy patterns corresponding to the strip-shaped portions 31B and 31C (see FIG. 4 B), it is not necessary to bother dividing the gate electrode section 30B or the narrow width section 30C.

Although such occurrence of the bulges is one of the cases in which the pattern of the liquid changes its configuration due to the influence of its kinetic behavior such as the wettability and surface tension, there is another characteristic case, which will now be described with reference to FIG. 9. FIG. 9 is a comparison example of the present embodiment and is a cross-sectional diagram of a conventional example of a liquid pattern.

A pattern 90 of a liquid shown in FIG. 9 is a cross-sectional diagram of a part corresponding to a region E in imaginary lines in FIG. 4A. In FIG. 9A, a narrow width section 90C (corresponding to the narrow width section 30C of FIG. 4A) is thinner than a wide width section 90A (corresponding to the wide width section 30A of FIG. 4A). Further, in FIG. 9B, the pattern of the liquid is not formed at the part of the narrow width section 90C, and the pattern 90 looks as if it is split apart in the middle.

As shown, at the part where two regions having different widths contact each other, the liquid moves between these two regions (the wide width section 90A and the narrow width section 90C in the case of FIG. 9), possibly creating uneven thickness or default in the film. According to an understanding of the inventors, it is thought that such a phenomenon as the movement of liquid is attributed to a difference in the surface curvature of the liquid between the wide width section 90A and the narrow width section 90C. In other words, when the pattern 90 is structured having a virtually even thickness, the surface of the liquid of the narrow width section 90C having a narrow width has a larger curvature than the surface of the liquid of the wide width section 90A having a wide width. Then, along with the difference in the curvature, a difference in inner pressure occurs as a result of trying to maintain equilibrium with the surface tension. This difference in the inner pressure causes the liquid to flow, thereby creating the pattern as shown in FIG. 9 in a normal state.

In the embodiment, as shown in FIG. 5, the design pattern 30 is divided into the sub-regions determined by the fixed widths, such as the sub-regions 40a and 40b determined by the width (20 μm) of the wide width section 30A, the sub-region 40c determined by the width (10 μm) of the gate electrode section 30B, and the sub-region 40d determined by the width (7 μm) of the narrow width section 30C. In these sub-regions having a configuration determinable by the fixed width, such as rectangle, the liquid does not flow as described above. Therefore, a stable configuration can be maintained, and, as a result, an evenly formed film can be obtained.

Additionally, a “configuration determinable by a fixed width” is not limited to rectangle as in the present embodiment. Other possibilities will be described hereinafter in modified examples 1-4.

As evident from the descriptions above, when forming the pattern of the liquid, the configuration and size of the design pattern are largely affected by the behavior of the liquid after it is discharged. According to the pattern formation method of the invention, the behavior of the liquid can be controlled per each sub-region regardless of the configuration or size of the design pattern, and, therefore, the pattern can be formed accurately in terms of the line width and configuration.

### MODIFIED EXAMPLE 1

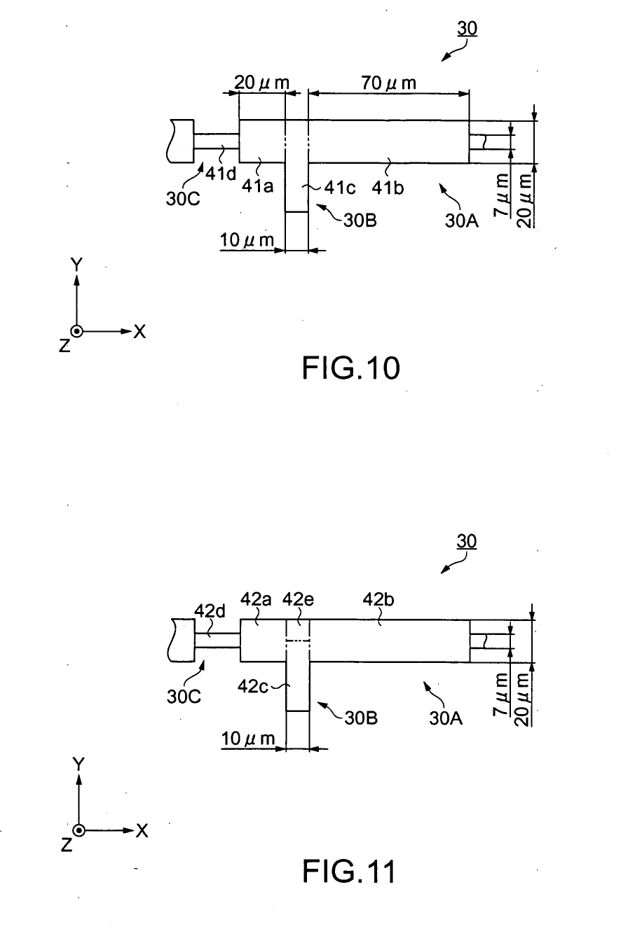

FIG. 10 is a diagram showing division of the design pattern of the gate wiring into sub-regions in a modified example 1. Hereinafter, descriptions for the same elements as those in the preceding embodiment will be omitted, and mainly the differences in the modified example 1 will be described.

As shown in FIG. 10, in the modified example 1, a sub-region 41c determined by the width (10 μm) of the gate electrode section 30B is established so as to extend into a portion of the wide width section 30A from the gate electrode section 30B. Further, the wide width section 30A includes a sub-region 41a in a shape of 20 μm×20 μm square and a sub-region 41b in a shape of rectangle having 20 μm in width×70 μm in length.

It is not necessary that the sub-region be divided by a connection part as their border that connects the wide width section 30A with the gate electrode section 30B as in this modified example 1. What is important is that the divided sub-regions are in the “configurations determinable by the nearly fixed widths,” and there are many variations.

Further, the wide width section 30A does not have to be evenly divided, either. What is important is to divide the wide width section into sub-regions having “lengths that do not allow the bulges to occur (the lengths not longer than the intervals of the bulge occurrence on the dummy pattern),” and there are many variations.

Furthermore, as regards the square-shaped sub-region 41a, even if the pattern of the liquid is formed to have the shape of square, whose width is undistinguishable from the length, it is obvious that this pattern can maintain a stable configuration. Thus, it cannot reasonably say that the square-shaped configuration is not the “configuration having the nearly fixed width.” In other words, the “configuration determinable by the nearly fixed width” in the invention should be specified also with respect to whether or not this pattern can maintain its stable configuration when the pattern having such a configuration is formed, and the square-shaped configuration is naturally one such configuration.

### MODIFIED EXAMPLE 2

FIG. 11 is a diagram showing division of the design pattern of the gate wiring into sub-regions in a modified example 2. Hereinafter, descriptions for the same elements as those in the modified example 1 and preceding embodiment will be omitted, and mainly the differences in the modified example 2 will be described.

As shown in FIG. 11, in the modified example 2, sub-regions 42c and 42e determined by the width (10 μm) of the gate electrode section 30B are established in a manner that the sub-region 41c in the modified example 1 is divided in a Y-axis direction. Thus, the establishment of a sub-region does not deny further division of the sub-region.

### MODIFIED EXAMPLE 3

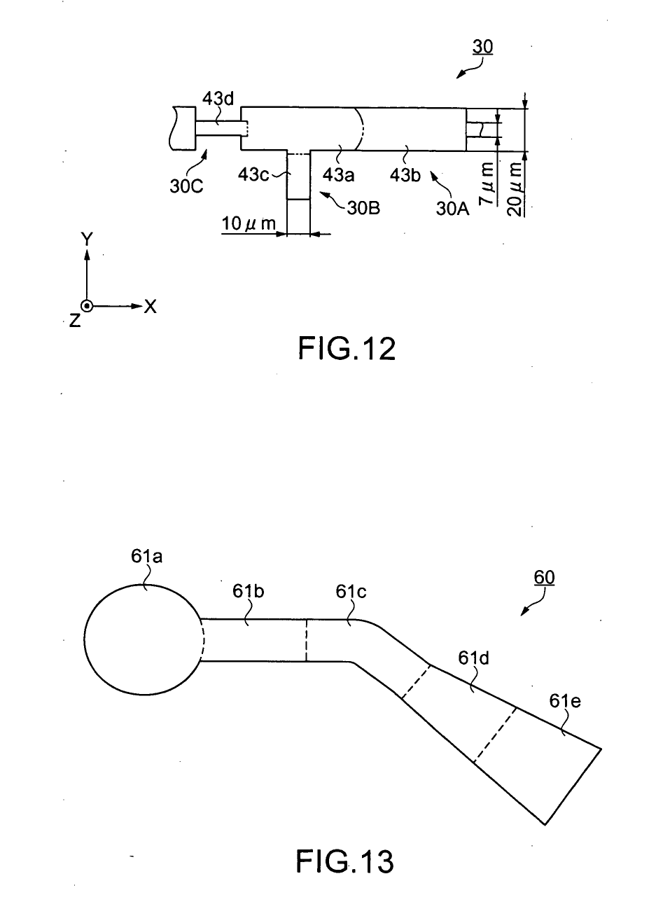

FIG. 12 is a diagram showing division of the design pattern of the gate wiring into sub-regions in a modified example 3. Hereinafter, descriptions for the same elements as those in the preceding embodiments will be omitted, and mainly the differences in the modified example 3 will be described.

As shown in FIG. 12, in the modified example 3, the wide width section 30A includes non-rectangular sub-regions 43a and 43b. Thus, a configuration that cannot exactly be called a rectangle, such as one having small level differences and curvatures in the contour, is also included as the “configuration determinable by the nearly fixed width” in the invention so long as the configuration has a nearly fixed width (in this case, 20 μm) when seen objectively.

### MODIFIED EXAMPLE 4

FIG. 13 is a diagram showing division of the design pattern of the gate wiring into sub-regions in a modified example 4. Hereinafter, descriptions for the same elements as those in the preceding embodiments will be omitted, and mainly the differences in the modified example 4 will be described.

In FIG. 13, a design pattern 60 of an electrode wiring contains a circular sub-region 61a, a near rectangular sub-region 61b, a bent and strip-shaped sub-region 61c, and trapezoidal sub-regions 61d and 61d.

The circular sub-region 61a, with its diameter taken as the width and its center taken as an axis of rotation, can be considered determinable by the fixed width in a direction of the rotation. Further, as in the case with the square configuration, it is obvious that this pattern can maintain its stable configuration even if the formed pattern of the liquid is circular. In other words, the “configuration determinable by the nearly fixed width” is a configuration determinable by the fixed width (diameter) in one direction of translation or rotation. Thus, the circular shape is one such “configuration determinable by the nearly fixed width” of the invention. Further, other such “configurations determinable by the nearly fixed width” are the bent and strip-shaped configuration, such as the sub-region 61c, and the trapezoidal configurations, such as the sub-regions 61d and 61e whose upper base and lower base have a small difference.

The invention is not limited to the above-described embodiments. For example, if the design pattern is structured having a multiple number of widths, the regions do not necessarily have to be divided so long as the configuration and the film thickness distribution are stabilized. Moreover, the structures in the embodiments can be suitably combined, omitted, or arranged with other structures that are not shown in the drawings.

What is claimed is:

1. A pattern formation method, in which a functional film of a specified pattern is formed on a substrate using a droplet discharging method, comprising:
establishing a plurality of sub-regions that divide a design pattern of the functional film;
conducting a first plotting step by disposing a first liquid so as to plot a borderline between the sub-regions; and
conducting a second plotting step by disposing a second liquid which contains a functional material functioning mainly as the functional film so as to plot the plurality of sub-regions after the first plotting step.

2. The pattern formation method according to claim 1, further comprising intermediately drying the first liquid disposed on the substrate so as to form a line-shaped film between the first plotting step and the second plotting step.

3. The pattern formation method according to claim 1, wherein the first liquid contains the functional material.

4. The pattern formation method the according to claim 1, wherein the first liquid contains a resin component.

5. The pattern formation method according to claim 1, further comprising establishing the sub-regions as regions having a configuration determinable by a nearly fixed width in the sub-region establishing step.

6. The pattern formation method according to claim 1, in which the design pattern of the functional film includes an elongated region and in which, in the sub-region establishing step, the sub-regions are established by dividing the elongated region along an elongation direction of the elongated region so as to have a length no larger than a specific length, wherein:
the specific length is equal to an interval between nearly evenly-spaced bulges which appear on a pattern of a liquid formed when the second liquid is disposed all at once so as to plot a strip-shaped pattern having a same width as that of the elongated region.

7. The pattern formation method according to claim 6, further comprising:
forming a dummy pattern on a dummy substrate prior to the sub-region establishing step by disposing the second liquid so as to plot the strip-shaped pattern having a same width as that of the elongated region; and
determining the specific length by the interval between the nearly evenly-spaced bulges that appear on the dummy pattern.

8. The pattern formation method according to claim 1, wherein a surface of the substrate having the pattern formed thereon is subjected to a liquid repellent treatment or a bank formation so as to surround a region corresponding to the design pattern of the functional film.

9. A functional film formed using a specified pattern, wherein:
the pattern of the functional film is composed of a line-shaped portion formed using a pattern as a borderline that divides the pattern of the functional film into a plurality of sub-regions and of a main portion that is partitioned by the line-shaped portion and formed using patterns corresponding to the sub-regions; and
at least the main portion contains a functional material functioning mainly as the functional film.

10. The functional film according to claim 9, wherein the line-shaped portion contains the functional material.

11. The functional film according to claim 9, wherein the sub-region is a region having a configuration determinable by a nearly fixed width.
